(19) United States
(12) Patent Application Publication
(10) Pub. No.: US 2026/0289328 A1
(43) Pub. Date: Sep. 24, 2026

(54) ENTROPY-BASED EARLY STOPPING FOR DRAFT TREE-BASED SPECULATIVE DECODING IN GENERATIVE MACHINE LEARNING MODELS

(71) Applicant: QUALCOMM Incorporated, San Diego, CA (US)

(72) Inventors: Sudhanshu AGRAWAL, San Diego, CA (US); Mukul GAGRANI, Milpitas, CA (US); Mingu LEE, San Diego, CA (US)

(21) Appl. No.: 19/086,578

(22) Filed: Mar. 21, 2025

(51) Int. Cl. G06N 5/01

(52) U.S. Cl. CPC G06N 5/01

(57) ABSTRACT

Certain aspects of the present disclosure provide techniques and apparatus for machine learning. In an example method, a set of leaf tokens of a draft tree comprising a plurality of tokens is generated using a secondary generative machine learning model associated with a primary generative machine learning model. A set of residual probability distributions for the set of leaf tokens is generated, and a set of entropies is computed based on the set of residual probability distributions. A set of drafting decisions for the set of leaf tokens is generated based on the set of entropies. The secondary generative machine learning model is exited from based on the set of drafting decisions and one or more stopping criteria for generation of a new token using the primary generative machine learning model.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, research has yielded substantial success in using foundation models, such as large language models (LLMs), large vison models (LVMs), and/or large multimodal models (LMMs), to process and generate output data. Often, machine learning models (especially LLMs, LVMs, and LMMs) have many parameters (e.g., millions or even billions), resulting in significant model size, as well as substantial computational expense and time to generate output using the model.

Some recent efforts to mitigate the computational expense of such generative models include speculative decoding, where a less computationally expensive model (referred to in some aspects as a “draft model”) can be used to generate a subset of the tokens in the output (rather than using the larger model, often referred to as the “target model,” for all tokens). Some approaches to speculative decoding utilize certain criteria to control switches between using the draft model and the target model.

### BRIEF SUMMARY

Certain aspects of the present disclosure provide a processor-implemented method, comprising: generating, using a secondary generative machine learning model associated with a primary generative machine learning model, a first set of leaf tokens of a first draft tree comprising a first plurality of tokens; generating a set of residual probability distributions comprising a respective residual probability distribution for each respective leaf token of the first set of leaf tokens; computing a set of entropies comprising a respective entropy of each respective leaf token of the first set of leaf tokens based on the set of residual probability distributions; generating a set of drafting decisions comprising a respective drafting decision for each respective leaf token of the first set of leaf tokens based on the set of entropies; and exiting from the secondary generative machine learning model based on the set of drafting decisions and one or more stopping criteria for generation of a new token using the primary generative machine learning model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for utilizing entropy measurements to perform drafting-tree-based speculative decoding, according to some aspects of the present disclosure.

FIG. 2 depicts a workflow for generating drafting decisions based on draft trees for speculative decoding, according to some aspects of the present disclosure.

FIG. 3 is a flow diagram depicting an example method for entropy-based speculative decoding, according to some aspects of the present disclosure.

FIG. 4 is a flow diagram depicting an example method for generating draft tokens using entropy-based stopping criteria, according to some aspects of the present disclosure.

FIG. 5 is a flow diagram depicting an example method for adaptive exiting criteria in entropy-based speculative decoding, according to some aspects of the present disclosure.

FIG. 6 is a flow diagram depicting an example method for speculative decoding, according to some aspects of the present disclosure.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for improved speculative decoding in drafting-tree-based systems are provided.

Many model architectures, such as transformer-based models (e.g., LLMs) and diffusion models (e.g., LVMs) have shown great promise in generating useful output data. However such generative models are often slow at inference time (e.g., taking substantial time to generate output tokens, where each token generally corresponds to a portion of the model output, such as a single character or word, a portion of a word, a pixel or other portion of an image, and the like) and are similarly computationally expensive (e.g., consuming substantial memory, as well as processor time and energy, and resulting in substantial heat generation). As a result, a variety of techniques have been developed to accelerate the token generation rate and/or reduce the computational expense of the token generation. One such technique includes speculative decoding, where a drafting phase is performed to produce “draft” tokens using a relatively less expensive and/or quicker draft model. These draft tokens can then undergo a verification phase to determine whether the draft tokens are “accepted” or “rejected” (e.g., by the slower and/or more computationally expensive target model) to produce the final set of output tokens.

In some systems, the draft tokens may be structured in the form of a tree (referred to herein as a “draft tree”) to allow for a greater number of possible completions, increasing the likelihood that one of the alternatives will be correct (and thereby reducing the computational expense of generating output). However, conventional techniques often set a static draft depth (e.g., the number of levels in the draft tree is fixed). Further, while some techniques have been proposed to prune the width of the draft tree (e.g., via top-k sampling and beam search), these techniques fail to address the depth of the tree. This leads to an inefficiency in the drafting process, as each level of the draft tree incurs an additional draft model call.

In some aspects of the present disclosure, entropy-based techniques for early stopping of the drafting process are provided in the context of such draft trees. In some aspects, the system can adaptively determine, at any given level of the draft tree, whether to continue drafting (e.g., generating another level) or to cease the drafting phase and transition to the verification phase (e.g., using the target or base model). In some aspects, the techniques described in more detail below can generate dynamic drafting decisions to account for the varying probability distributions inherent to the structure of the draft tree.

In some aspects of the present disclosure, the system may generate a drafting decision for one or more leaf nodes of the draft tree (e.g., nodes or tokens which have no children) in order to determine whether to generate a new level (e.g., a new set of leaf nodes as children of the current leaf nodes) or to terminate the drafting phase (e.g., to evaluate the draft tokens using the target model). As used herein, a node on the draft tree may alternatively be referred to as a “node” or a “token.” For example, a “leaf node” may alternatively be referred to as a “leaf token” to signify that the node (or token) has no children. Similarly, a node or token may be referred to as a “branch node” or “branch token” to indicate that the node or token has at least one child and at least one parent. Further, a node or token may be referred to as a “root node” or “root token” to indicate that the node has no parents in the draft tree. In some aspects, the drafting decision for each leaf node may be generated based in part on the residual probability distribution of the token. In some aspects, the residual probability of a given leaf node is defined based in part on the probability of the leaf node's parent token as well as the probability of one or more sibling nodes (e.g., other leaf nodes with the same parent), as discussed in more detail below. In some aspects, the residual probability distribution of a given leaf node may be thought of as the probability of the leaf node if the probability values for the previous siblings (e.g., the sibling nodes having higher probability than the given leaf node) is set to zero and the remaining distribution (e.g., of the given leaf node and any subsequent sibling nodes) is renormalized such that the values sum to one, as discussed below in more detail.

In some aspects, the system can then compute the entropy of the residual probability distribution of each leaf node, and compare these entropy values to one or more thresholds (referred to in some aspects as “early-exit thresholds”) to generate the drafting decision for each leaf node. That is, some aspects of the present disclosure can enable evaluation of the entire residual probability of the token, which inherently accounts for the shape of the draft tree and can significantly improve the speculative decoding process (e.g., because this entropy-based approach takes into account the full spectrum of data generated by the draft model and the structure of the tree itself).

In some aspects, as used herein, a “target model” may generally refer to a generative machine learning model from which output generated data is desired. For example, the target model may correspond to an LLM being used to generate outputs. In some aspects, the target model may incur fairly substantial latency and/or computational expense to generate output tokens (e.g., due to the size of the model). Similarly, as used herein, a “draft model” may generally refer to a smaller and/or less complex generative machine learning model that can be used as a surrogate for the target model in some cases (e.g., generating similar output, potentially with somewhat reduced accuracy or quality). Generally, the draft model may incur less latency and/or computational expense to generate output tokens, as compared to the target model, such as due to the relatively smaller size and/or lower complexity of the draft model.

Generally, the particular architecture or techniques used to implement the draft model may vary depending on the particular implementation. For example, in some aspects, the draft model may comprise a separate or discrete model from the target model, or may be implemented as a subset of the target model's layers (e.g., where the draft model corresponds to every other layer of the target model). In some aspects, the draft model may be implemented using extra parameters in the target model itself to generate draft tokens.

In some aspects, in addition to or instead of evaluating the entropy of the tokens corresponding to the leaf nodes during drafting, the speculative decoding system can utilize adaptive stopping criteria based on the acceptance rate of the target model. For example, during each verification phase (after a set of draft tokens have been generated during the drafting phase), the system may determine the acceptance rate of the draft tokens for the current drafting phase and/or one or more prior drafting phases, and may adaptively adjust the stopping criteria used to define when the drafting phase ends accordingly, as discussed in more detail below.

Example Workflow for Utilizing Entropy Measurements to Perform Speculative Decoding

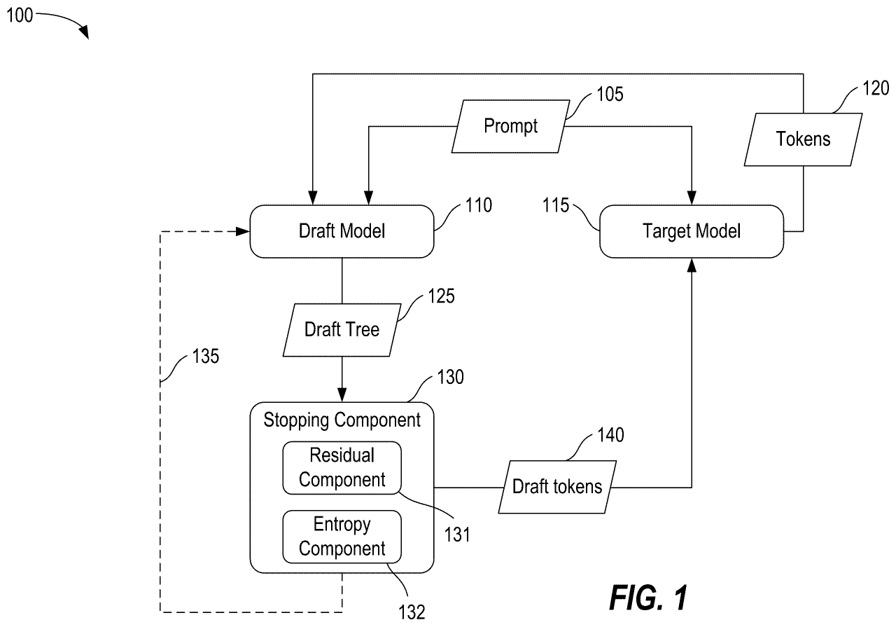

FIG. 1 depicts an example workflow 100 for utilizing entropy measurements to perform drafting-tree-based speculative decoding, according to some aspects of the present disclosure. In some aspects, the workflow 100 is performed by a computing system (e.g., a speculative decoding system). That is, the workflow 100 may be performed by any computing system configured to perform speculative decoding, as discussed above and herein. In some aspects, the workflow 100 may be performed by multiple discrete systems. For example, one computing system (e.g., a portable device) may implement the draft generative model, while another computing system (e.g., a server) implements the target generative model. In other aspects, the same computing system may implement both the draft generative model and the target generative model.

In the illustrated example, a prompt 105 (also referred to in some aspects as a “query”) is accessed by a draft model 110 and a target model 115. As used herein, “accessing” data may generally include receiving, retrieving, obtaining, collecting, generating, or otherwise gaining access to the data. For example, the prompt 105 may be received from a user or entity that uses the machine learning model(s) to generate output. Generally, the particular content and format of the prompt 105 may vary depending on the particular implementation. For example, in some cases, the prompt 105 may comprise textual information (e.g., natural language text) for use as input to an LLM to generate textual output (e.g., a natural language text response).

In the depicted workflow 100, the target model 115 (also referred to in some aspects as the “primary model,” the “primary machine learning model,” and/or as the “primary generative machine learning model”) generally corresponds to a generative machine learning model used to generate output data based on input prompts. For example, as discussed above, the target model 115 may correspond to a foundation model, such as an LLM, LVM, LMM, or the like. In some aspects, the target model 115 may be relatively computationally expensive (e.g., incurring substantial latency and/or computational resource usage) during runtime. Further, in the illustrated example, the draft model 110 (also referred to in some aspects as the “secondary model,” the “secondary machine learning model,” and/or as the “secondary generative machine learning model”) generally corresponds to a generative machine learning model that can also be used to generate output data based on input prompts. In some aspects, as discussed above, the draft model 110 may be relatively less computationally expensive than the target model 115 (e.g., incurring less latency and/or computational resource usage, as compared to the target model 115) during runtime.

In some aspects, the draft model 110 may be somewhat less accurate or reliable than the target model 115. However, not all tokens in a generated output are equally “difficult” to generate. Therefore, in some aspects, the draft model 110 may be reliably used to generate some tokens, even if the target model 115 is relied upon for other tokens. Knowing the “difficulty” of a given token (before drafting the token) is, generally speaking, nearly impossible. In some aspects, therefore, the depicted workflow 100 can be used to implement speculative decoding. Generally, as discussed above, speculative decoding involves using the target model 115 to generate some set of tokens in the output, while allowing the draft model 110 to generate another set of one or more tokens. These tokens generated by the draft model 110 (referred to as “draft tokens” in some aspects) can then be evaluated (e.g., using the target model 115) to verify the draft tokens. That is, the target model 115 may accept zero or more of the draft tokens, and the target model 115 may reject zero or more of the draft tokens (e.g., because the token is too dissimilar from what the target model 115 would have generated).

In some aspects, because the draft model 110 is less computationally complex than the target model 115, the set of draft tokens can be generated more rapidly and with less computational expense, as compared to generating the set using the target model 115 alone. Further, because the target model 115 may evaluate multiple draft tokens in parallel (e.g., evaluating the entire sequence of draft tokens at once), the target model 115 can be used to quickly verify the draft tokens. By combining these features, the workflow 100 can substantially accelerate the output generation process.

In the illustrated example, the target model 115 may process the prompt 105 to generate a set of one or more tokens 120. As used herein, a “token” corresponds to a unit of output of the model(s). Generally, the particular format and content of a token may vary depending on the particular implementation. For example, in some aspects, the tokens 120 comprise words, phrases, alphanumeric characters and/or symbols, and the like. Generally, the particular number of tokens 120 to be generated using the target model 115 may vary depending on the particular implementation. For example, in some aspects, the computing system may generate a single token 120 using the target model 115 in between each drafting phase (e.g., before using the draft model 110). As another example, the computing system may use the target model 115 to generate two or more tokens 120 between drafting phases.

In the illustrated workflow 100, these initial tokens 120 are provided, along with the prompt 105, to the draft model 110, to generate a draft tree 125 comprising a set of one or more draft tokens. In some aspects, as discussed above, the draft tokens in the draft tree 125 may be referred to as “draft” tokens to indicate that these draft tokens were generated by the draft model 110 and have not (yet) been verified by the target model 115. Generally, the particular number of tokens to be generated using the draft model 110, as well as the structure and/or dimensionality of the draft tree 125, may vary depending on the particular implementation. For example, in some aspects, the computing system may generate a set of draft tokens at a given level of the draft tree 125 (e.g., child nodes of the root, which may correspond to the last (verified) token in the current set of tokens 120), then evaluate the early-exit and/or stopping criteria to determine whether to continue drafting (e.g., to generate a next level) or to cease the drafting (e.g., to return the tokens to the target model 115 for verification). That is, the depth of the draft tree 125 may be determined dynamically during the drafting phase.

In some aspects, the width of the draft tree 125 may be determined as a hyperparameter (e.g., specifying the number of child nodes that should be generated for each parent node at a given level) and/or using other techniques (such as based on the quality scores of each token). For example, the computing system may, at any given level, identify a subset of the current leaf nodes having the highest quality (e.g., using techniques such as beam search, top-k selection, and the like), and mark this subset as the “active” leaf tokens (e.g., tokens for which additional children may be generated) while the remaining leaf tokens may be marked as “inactive” (e.g., such that the computing system refrains from generating further draft tokens as children of these inactive nodes). In some aspects, the quality score of the tokens may be determined based on, for example, the confidence score generated for the given token by the draft model 110.

In the illustrated example, the draft tree 125 generated by the drafting model 110 (which may be a new tree, or may be a prior-generated tree with a new set of leaf nodes, as discussed above) is accessed by a stopping component 130 to determine whether to stop the drafting phase. As used herein, stopping the drafting phase (also referred to in some aspects as “early exiting” or “exiting” from the drafting phase and/or from the draft model) generally corresponds to determining to use the target model 115 for the next one or more token(s) of the output, rather than using the draft model 110 for the next token(s). That is, stopping the drafting phase may include providing all or a subset of the draft tree 125 (e.g., the draft tokens 140) for verification by the target model 115 (where such verification may also include generation of at least one new output token 120).

In the illustrated workflow 100, the stopping component 130 includes a residual component 131 and an entropy component 132. The residual component 131 may be used to generate residual probability distributions for one or more leaf nodes (e.g., the “active” leaf nodes, as discussed above, which may be all of the leaves) in the draft tree 125. For example, in some aspects, when generating the draft tokens in the draft tree 125, the draft model 110 also generates a set of probabilities for each of one or more alternative output tokens (e.g., a probability distribution where the particular probability score for a particular token indicates the probability that the particular token should be selected as an output token and/or for inclusion in the draft tree 125. In some aspects, it is these probabilities that are used to determine the quality score or confidence score of each draft token (e.g., where higher probabilities indicate higher confidence or quality).

In some aspects, the residual probability distribution of a given leaf token (e.g., a token corresponding to a leaf node of the draft tree 125) may be defined using Equation 1 below, where p_{x,n} is the residual probability distribution of the token that is at the n-th position of parent token x. That is, the given token's parent is token x, and the position (also referred to as the index) of the given token is defined as the token's position among its siblings (e.g., in the ordering of the children of the parent token x). For example, if the parent token x has three child nodes or tokens, each of these child tokens may be quantified (e.g., using a quality score, such as the confine score generated for the child token by the draft model 110). In such an aspect, the “position” or “index” of a given token corresponds to its position in the ranked or ordered set of its siblings (e.g., first, second, or third based on sorting the tokens according to quality scores in descending order). Further, in Equation 1, the probability distribution of the parent token may be defined as pₓ, and pₓ(i) is the probability distribution of the i-th child token of the parent (e.g., the child at the i-th index).

$${p}_{x , n} = \frac{{p}_{x} - {\sum }_{i = 1}^{n - 1} {p}_{x} ( i )}{1 - {\sum }_{i = 1}^{n - 1} {p}_{x} ( i )} \qquad ( 1 )$$

In some aspects, once the residual probability distribution(s) have been generated each active leaf token in the draft tree 125, the entropy component 132 may generally be used to evaluate or compute the entropy of each active leaf token based on the corresponding residual probability distribution.

For example, the entropy of a given draft token generated by the draft model 110 may be defined as H_{DM}(p_{x,n}) (e.g., the entropy of the residual probability of the given token). In some aspects, the stopping component 130 may compare this entropy against one or more thresholds to generate a drafting decision (also referred to as an early exit decision in some aspects) for the given token. In some aspects, rather than comparing the entropy directly against one or more thresholds, the stopping component 130 may use an equation, such as Equation 2 below, to generate an early-exit score for the given token. In Equation 2, score is the early-exit score, and γ is a hyperparameter.

$$score = 1 - \sqrt{γ {H}_{D M} ( {p}_{x , n} )} \qquad ( 2 )$$

In some aspects, this early-exit score may be compared against an early-exit threshold λ. For example, in some aspects, if score <λ, the stopping component 130 may determine that the early-exit criteria are satisfied (e.g., the drafting decision of the given token is to terminate the drafting phase), while if the score is greater than or equal to the threshold, the drafting decision of the given token is to continue drafting. Generally, the stopping component 130 may use a variety of inequalities to evaluate the exit score, including strictly less than, not greater than (e.g., less than or equal to), strictly greater than, not less than (e.g., greater than or equal to), and the like. In some aspects, the stopping component 130 may therefore determine that the early-exit criteria are satisfied if the entropy is high (e.g., the drafting phase should be stopped when the early-exit score is low), while the early-exit criteria may be not satisfied if the entropy is low (e.g., the drafting phase should continue when the early-exit score is high).

In some aspects, the early-exit threshold λ is a hyperparameter. In some aspects, the early-exit threshold may be a dynamic or adaptive threshold. For example, in some aspects, the early-exit threshold may be defined dynamically based on the moving average of the acceptance rate of the target model 115 with respect to the draft tokens generated by the draft model 110, as discussed in more detail below.

In some aspects, as discussed above, the stopping component 130 may thereby generate a respective drafting decision for each of a set of draft tokens (e.g., for each leaf token of the draft tree 125 or for a subset thereof, such as for the “active” leaf tokens). In some aspects, the stopping component 130 can then evaluate these drafting decisions using various stopping criteria in order to determine whether to terminate the drafting phase.

For example, in some aspects, the stopping criteria comprise a majority voting approach, where if the majority of the drafting decisions indicate to continue drafting, drafting continues. Otherwise, drafting is stopped. For example, the overall or aggregated stopping decisions (also referred to in some aspects as aggregated drafting decisions) may be defined as sign(Σᵢdecⁱ), where decⁱ is the drafting decision of the i-th leaf token, a “continue drafting” drafting decision has a value of −1, and a “stop drafting” drafting decision has a value of 1.

As another example, in some aspects, the stopping criteria may comprise a weighted majority voting, where the drafting decision decⁱ of the i-th leaf token is weighted by a weight factor wⁱ. That is, the weighted decision may be defined as sign (Σᵢwⁱdecⁱ) (e.g., where a value less than or equal to zero indicates a vote to continue drafting, while a value greater than zero (e.g., a positive value) indicates a vote to cease drafting). Generally, a variety of weight definitions may be used. For example, in some aspects, if each token is weighted equally, this weighted approach is equivalent to the above-discussed simple majority approach. In some aspects, the weight of a given leaf token may be defined based on the probability of the given leaf token, the entropy of the residual probability of the given leaf token, the position or index of the given leaf token (e.g., the ordering of the leaves), and the like. The weight of the i-th token may be defined as wᵢ=Σ_{i∈seq} log(pᵢ) (e.g., the sum of the log probabilities of all ancestors of the given leaf token, where a high value indicates that the leaf, and its ancestors, have high probabilities). As another example, the weight of the i-th token may be defined as w_{1, . . . , m}=1, w_{m+1, . . . , k}=0. That is, the stopping component 130 may consider only the drafting decision of the first m nodes (e.g., the siblings, relative to a given parent, with the highest m quality or confidence scores).

In some aspects, the stopping criteria may be defined based on a confidence-weighted majority vote. For example, the weight of the i-th token may be defined as

$$\frac{log ( {c}_{i} )}{1 - log ( {c}_{i} )} ,$$

where cᵢ is the confidence of the i-th token, and the confidence cᵢ may be defined in various ways. As one example, the confidence of the i-th token cᵢ may be defined as the logits of the residual probability distribution of the token.

As another example, in some aspects, the confidence of the i-th token may be defined by first computing an initial confidence value c_{initial,i}=clip(1−γH_{DM}(p_{x,n})−λ, min=λ−1, max=λ+1), and then computing the confidence value as

$${c}_{i} = abs ( - 1 + \frac{{c}_{i n i t ial , i} - ( λ - 1 )}{λ} ( 2 ) ) .$$

As another example, in some aspects, the stopping component 130 may first determine a value μ=\sqrt{1−γ logₑ(vocab_size)} (where vocab_size is the size of the vocabulary of the model(s)), as well as an initial confidence value of the i-th token according to c_{initial,i}=clip (1−\sqrt{γH_{DM}(p_{x,n})}−λ, min=μ, max=1). The confidence value of the i-th token may then be defined as

$${c}_{i} = abs ( - 1 + \frac{{c}_{i n i t ial , i} - μ}{1 - μ} ( 2 ) )$$

(e.g., normalizing the initial value to (−1,1) and then taking the absolute value).

As yet another example, in some aspects, the stopping component 130 may first determine a value μ=1−\sqrt{γ logₑ(vocab_size)}, as well as an initial confidence value of the i-th token according to c_{initial,i}=1−\sqrt{γH_{DM}(p_{x,n})}−λ. If the initial confidence value c_{initial,i} is greater than or equal to zero, the confidence value of the i-th token may then be defined as

$${c}_{i} = \frac{{c}_{i n i t ial , i}}{1 - λ}$$

(e.g. the initial value to (0,1)). If the initial confidence value c_{initial,i} is less than zero, the confidence value of the i-th token may then be defined as

$${c}_{i} = 1 - \frac{{c}_{i n i t ial , i} - ( μ - λ )}{0 - ( μ - λ )}$$

(e.g., normalizing the initial value to (0,1) and then flipping the values in that normalized range).

Generally, any suitable approach may be used to define the confidence value of a given token and/or to define the weight of the corresponding drafting decision.

Although the illustrated example depicts use of entropy to determine exit criteria from the drafting phase, in some aspects, the stopping component 130 may use a variety of other criteria to determine when to exit the drafting phase. For example, the stopping component 130 may additionally or alternatively determine whether the current sequence of draft tokens (generated by the draft model 110 during the current drafting phase) meets a defined maximum draft length hyperparameter (e.g., a defined maximum number of levels in the draft tree 125 that should be generated in a given drafting phase).

In the illustrated workflow 100, if the stopping component 130 determines to continue the drafting phase, as illustrated by the dotted arrow 135, the draft model 110 may be prompted to generate a new draft tree 125 (e.g., by generating one or more new leaf tokens for the prior draft tree 125). For example, the computing system may use the prompt 105, the tokens 120, and the previously generated draft tokens (e.g., the current leaf nodes of the draft tree 125) as input. This process can then be repeated (e.g., generating and evaluating a new set of leaf tokens) until the one or more stopping criteria are satisfied.

As illustrated, if the stopping component 130 determines to exit from the draft model 110 (e.g., due to high entropy of the leaf tokens), the set of generated draft tokens 140 (e.g., the draft tokens of the draft tree 125) is provided for verification to the target model 115. That is, when the drafting phase terminates, the entire draft tree 125 or a subset of draft tokens therefrom may be provided to the target model 115 for verification.

In some aspects, as discussed above, the target model 115 may be used to verify the draft tokens 140. For example, the prompt 105, any tokens 120 that have already been drafted by the target model 115, and the set of draft tokens 140 may be provided as input, allowing the target model 115 to verify (e.g., accept) or reject each token of the sequence of draft tokens 140. For example, the target model 115 may generate a score for each token in the sequence of draft tokens 140, accepting tokens having a score above a threshold (e.g., indicating a higher probability that the target model 115 would have generated the same token) and rejecting tokens having a score below the threshold (e.g., indicating a low probability that the target model 115 would have generated the same token).

In some aspects, this verification process also results in generation of a new next token 120 to be added to the sequence of (accepted) tokens. As illustrated, this updated sequence of tokens can then be provided to the draft model 110 to begin the next drafting phase, as discussed above. Although the illustrated example suggests that the target model 115 is used to generate the first token(s) in the output sequence (followed by alternating between the draft model 110 and the target model 115), in some aspects, the draft model 110 may be used to generate the first token(s) (followed by alternating between the draft model 110 and the target model 115).

In some aspects, as discussed above, the acceptance rate of the target model 115 may be used to dynamically or adaptively update the early-exit threshold used to generate drafting decisions during the drafting phase. For example, in some aspects, the computing system may calculate an updated moving average acceptance rate of the target model 115 using Equation 3 below, where α_{updated_ma} is the updated moving average acceptance rate, β₁ is a hyperparameter, α_{previous_ma} is the previous moving average acceptance rate (e.g., determined after the prior drafting phase), and α_{current} is the current acceptance rate of the target model 115 (e.g., determined based on the set of draft tokens 140 after the most recent drafting phase). For example, α_{current} may be computed as the percentage of tokens, from the set of draft tokens 140 generated during the immediately prior drafting phase, which the target model 115 accepted.

$${α}_{updated \_ ma} = {β}_{1} {α}_{p revious \_ ma} + ( 1 - {β}_{1} ) {α}_{c u r rent} \qquad ( 3 )$$

In some aspects, the computing system may then determine a target acceptance threshold or rate (e.g., a desired or target percentage of draft tokens, which may be defined as a hyperparameter). Generally, balancing the target acceptance rate can optimize or at least improve the computational efficiency of the models.

In some aspects, if the updated moving average acceptance rate is less than (or less than or equal to) the target acceptance rate, the computing system may generate a new updated early-exit threshold (e.g., by increasing the current threshold), such as by using Equation 4 below, where λ′ is the updated or new early-exit threshold, λ is the current threshold, and ∈ is a hyperparameter. By increasing the early-exit threshold, the computing system may make the stopping component 130 more likely to terminate the drafting phase (e.g., generating “stop drafting” drafting decisions when entropy is relatively lower, as compared to the prior round), which may result in an increased acceptance rate of the draft tokens 140.

$${λ}^{′} = min ( 1 , λ + ϵ ) \qquad ( 4 )$$

In some aspects, if the updated moving average acceptance rate is greater than (or greater than or equal to) the target acceptance rate, the computing system may determine a maximum length of the sequence of draft tokens (e.g., a maximum depth of the draft tree 125), which may be defined as a hyperparameter, as well as the number of draft tokens, from the sequence of draft tokens 140, which were accepted by the target model 115.

In some aspects, if the number of accepted draft tokens is equal to the maximum draft length for the computing system, the computing system may leave the early-exit threshold unchanged (e.g., λ′=1).

In some aspects, if the number of accepted draft tokens is less than the maximum draft length for the computing system, the computing system may generate a new updated early-exit threshold (e.g., by decreasing the current threshold), such as by using Equation 5 below. By decreasing the early-exit threshold, the computing system may make the stopping component 130 more likely to continue the drafting phase (e.g., generating “continue drafting” drafting decisions when entropy is relatively higher, as compared to the prior round), which may result in increased draft lengths (e.g., nearer to the maximum length), thereby improving the computational efficiency of generating the output.

$${λ}^{′} = max ( 0 , λ - ϵ ) \qquad ( 5 )$$

In some aspects, rather than using the updated threshold directly, the computing system may generate the updated moving average of the threshold, such as using Equation 6 below, where λ_{updated} is the updated early-exit threshold, β₂ is a hyperparameter, λ is the previous threshold (e.g., determined after the prior drafting phase), and λ′ is the updated threshold (e.g., determined as discussed above using Equations 4 and 5).

$${λ}_{u pdated} = {β}_{2} λ + ( 1 - {β}_{2} ) {λ}^{′} \qquad ( 6 )$$

Advantageously, this dynamic early-exit thresholding may automatically improve the computational efficiency of the system, enabling improved model output generation with reduced computational expense and/or latency. Although not depicted in the illustrated example, in some aspects, the output generation can continue (token by token) until one or more termination criteria are satisfied. For example, the computing system may continue to generate tokens until interrupted (e.g., until the requesting entity terminates the process), until a “complete” token or other token indicating the end of the output is generated and/or accepted, and/or until the sequence of output tokens reaches a maximum output length. This generated output can then be output by the computing system (e.g., returned to the requesting entity).

### Example Method for Entropy-Based Speculative Decoding

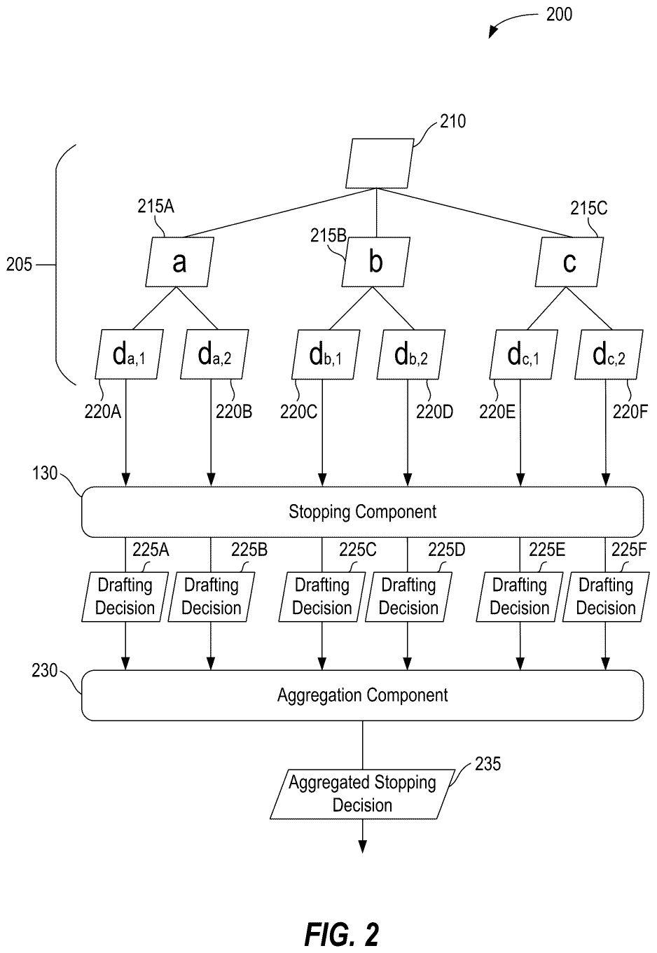

FIG. 2 depicts a workflow 200 for generating drafting decisions based on draft trees for speculative decoding, according to some aspects of the present disclosure. In some aspects, the workflow 200 is performed by a computing system (e.g., a speculative decoding system), such as the computing system discussed above with reference to FIG. 1.

In the illustrated example, a draft tree 205 (which may correspond to the draft tree 125 of FIG. 1) comprising a plurality of tokens is depicted. In the illustrated example, the token 210 may correspond to a verified or accepted token (e.g., the current final token generated or verified by the target model, such as the token 120 of FIG. 1), while the remaining tokens 215A-C and 220A-F may correspond to draft tokens (e.g., tokens generated during a current drafting phase using the draft model). In the draft tree 205, the tokens 220A-F may be referred to as leaf tokens to indicate that these tokens 220A-F are at the (current) deepest level of the draft tree 205.

In the illustrated example, each leaf token 220 is labeled to indicate the leaf token's parent and the leaf token's position or index with respect to the parent. For example, the leaf token 220A (labeled “d_{a,1}”) is the first child (e.g., the token at the first index) of the parent token a. Similarly, the leaf token 220B (labeled “d_{a,2}”) is the second child (e.g., the token at the second index) of the parent token a. In some aspects, as discussed above, the ordering of the sibling tokens (e.g., tokens sharing the same parent token) may be defined based on the relative probabilities of the tokens (e.g., based on the quality scores or confidence scores of each token). For example, the siblings may be sorted in descending order such that the token at the first index has a higher probability or quality than the token at the second index. In some aspects, the “quality” of the tokens used to determine their relative ordering may be defined based on the sum of the log probabilities of that token and the token's ancestors in the draft tree 205 (e.g., the cumulative log probability of the token).

In the illustrated example, as discussed above, each of the leaf tokens 220A-F may be evaluated by the stopping component 130 to generate a corresponding drafting decision 225A-F. For example, as discussed above, the stopping component 130 may, for each respective leaf token 220, generate a respective residual probability distribution. The stopping component 130 can then compute the entropy of this residual probability distribution to generate a score for each leaf token 220, and may compare the score against one or more thresholds to generate the drafting decision 225 of each given leaf token.

In the illustrated example, the drafting decisions 225 are evaluated by an aggregation component 230 to generate an aggregated stopping decision 235. For example, as discussed above, the aggregation component 230 may enact a simple majority voting system where each drafting decision 225 has equal weight. In some aspects, the aggregation component 230 may implement a weighted voting system, where the weight of any given drafting decision 225 (or token 220) may be determined using a wide variety of algorithms or techniques, as discussed above.

As discussed above, this aggregated stopping decision 235 may then be evaluated to determine whether to terminate the drafting phase (e.g., whether to provide some or all of the draft tree 205 for verification by the target model) or to continue the drafting phase (e.g., to generate a new set of leaf tokens, such that the current leaf tokens 220 themselves become parent tokens). For example, as discussed above, the aggregated stopping decision 235 may be compared against one or more stopping criteria (e.g., thresholds) to determine whether to terminate drafting (or, in some aspects, the aggregated stopping decision 235 may itself be a binary decision indicating whether to terminate drafting).

### Example Method for Entropy-Based Speculative Decoding

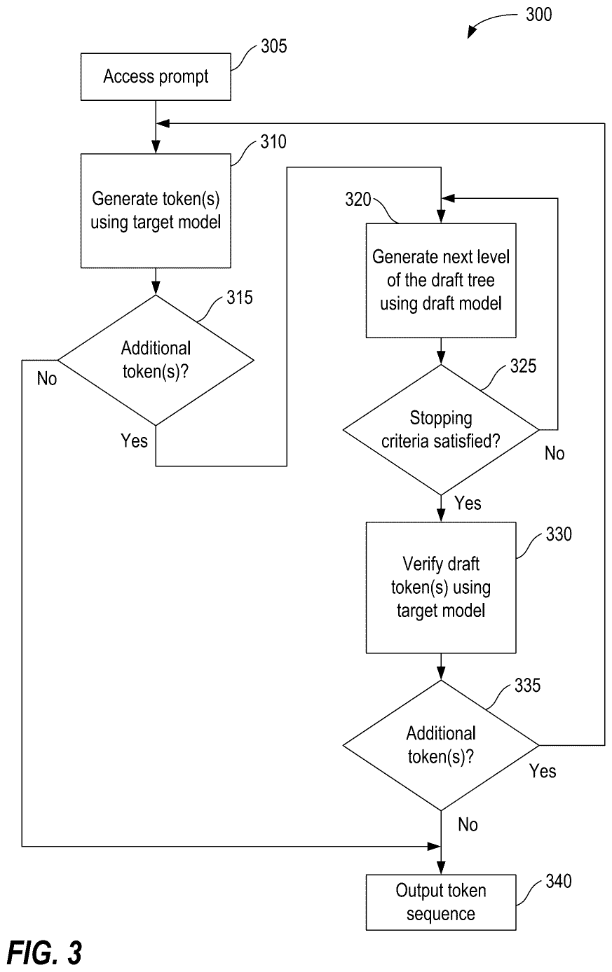

FIG. 3 is a flow diagram depicting an example method 300 for entropy-based speculative decoding, according to some aspects of the present disclosure. In some aspects, the method 300 is performed by a computing system (e.g., a speculative decoding system), such as the computing system discussed above with reference to FIGS. 1-2.

At block 305, the computing system accesses a prompt (e.g., the prompt 105 of FIG. 1) to generate a generative machine learning model output. For example, as discussed above, the prompt may comprise text (e.g., natural language text) describing the desired output (e.g., asking a question, requesting an image be generated, and the like). The particular contents and format of the prompt may vary depending on the particular implementation.

At block 310, the computing system generates one or more tokens (e.g., the tokens 120 of FIG. 1) based on the prompt and using a target generative machine learning model (e.g., the target model 115 of FIG. 1). As discussed above, the target model generally corresponds to a generative machine learning model that can be used to generate output based on the prompt. In some aspects, the target model has relatively high computational complexity and/or latency (as compared to the draft model, discussed in more detail below). In some aspects, the computing system generates a single “initial” token at block 310 using the target model. In some aspects, the computing system may bypass block 310 during the initial iteration of generating output (e.g., the computing system may generate the initial token(s) using the draft model, rather than the target model). Generally, the computing system (e.g., by the draft model, the target model) may generate any number of tokens at block 310.

At block 315, the computing system determines whether to generate at least one additional token for the output of the model. Generally, the computing system may evaluate a variety of criteria to determine whether to terminate the output generation. For example, in some aspects, the computing system may determine whether the most recently generated token(s) (e.g., generated at block 310) include an “end” token (or other token signifying the end of the generated output). As another example, in some aspects, the computing system may determine whether a defined (maximum) number of tokens have been generated (e.g., whether the generated output has reached the maximum length imposed on the models).

If, at block 315, the computing system determines that no additional tokens remain to be generated, the method 300 continues to block 340, discussed in more detail below. If, at block 315, the computing system determines that at least one additional token should be generated for the output, the method 300 continues to block 320.

At block 320, the computing system generates a next level of the draft tree (e.g., the draft tree 125 of FIG. 1 and.or the draft tree 205 of FIG. 2) comprising one or more draft tokens (e.g., a new set of leaf nodes 220 of FIG. 2) based on the prompt and using a draft generative machine learning model (e.g., the draft model 110 of FIG. 1). As discussed above, the draft model generally corresponds to a generative machine learning model that can be used to generate output based on the prompt (and, in some aspects, the current sequence of output tokens that has already been generated and/or accepted by the target model). In some aspects, the draft model has relatively lower computational complexity and/or latency (as compared to the target model, discussed above). For example, the draft model may use fewer layers or operations (e.g., every other layer of the target model), a different model architecture, and the like.

In some aspects, the computing system generates a single level of draft tokens at block 320 using the draft model. That is, during the drafting phase (which begins at block 320), the computing system may generate one level of draft tokens at a time (e.g., a new set of leaf tokens indicating possible next tokens for the output), evaluating drafting early-exit and/or stopping criteria between each level generation. In some aspects, at block 320, the computing system generates a set of tokens (e.g., one or more new leaf tokens for each current leaf in the tree), and orders these sibling tokens based on various criteria (such as the quality of the tokens, indicated by the probabilities generated by the draft model).

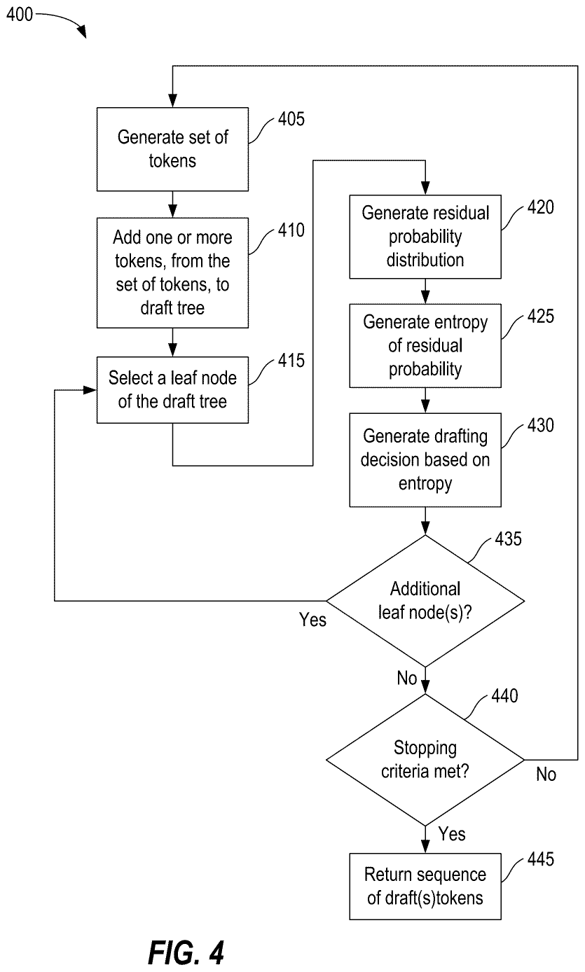

At block 325, the computing system determines whether one or more stopping criteria are satisfied. For example, as discussed above, the computing system may generate drafting decisions for at least a subset of the (newly generated) leaf nodes in the draft tree, and may aggregate or otherwise compare these drafting decisions against one or more criteria (e.g., using weighted majority voting, as discussed above). One example method for generating the new updated draft tree (at block 320) and evaluating the stopping criteria (at block 325) is discussed in more detail below with reference to FIG. 4.

Although not depicted in the illustrated example, in some aspects, the computing system may similarly evaluate other stopping criteria at block 325, such as whether one or more of the most recently generated draft tokens (e.g., the leaves generated at block 320) includes a token signifying the end of the generated output, whether a defined (maximum) number of tokens or tree depth has been reached, and the like.

If, at block 325, the computing system determines that the stopping criteria are not satisfied (e.g., that the computing system should continue the drafting phase and use the draft model to generate at least one more set of new leaf tokens), the method 300 returns to block 320 to generate at least one additional (leaf) token using the draft model. In some aspects, as discussed above, this may be referred to as generating a “next” token using the draft model.

If, at block 325, the computing system determines that the stopping criteria (or other exit criteria) are satisfied, the method 300 continues to block 330. At block 330, the computing system verifies the set of draft token(s) (generated during one or more iterations of block 320) using the target model. For example, as discussed above, the computing system may process some or all of the draft tokens contained in the draft tree as input to the target model, allowing the target model to accept or reject each draft token (or, in some aspects, allowing the computing system to score each draft token, where the scores can be evaluated to accept or reject each).

At block 335, the computing system determines whether to generate at least one additional token for the output of the model. As discussed above, the computing system may generally evaluate a variety of criteria to determine whether to terminate the output generation. For example, in some aspects, the computing system may determine whether the most recently generated or verified token(s) (e.g., generated at block 320 and verified at block 330) include an “end” token (or other token signifying the end of the generated output). As another example, in some aspects, the computing system may determine whether a defined (maximum) number of tokens have been generated (e.g., whether the generated (and verified) output has reached the maximum length imposed on the models).

If, at block 335, the computing system determines that no additional tokens remain to be generated, the method 300 continues to block 340, discussed in more detail below. If, at block 335, the computing system determines that at least one additional token should be generated for the output, the method 300 returns to block 310 to generate another “next” token using the target model. In some aspects, as discussed above, the computing system may alternatively generate the new token while verifying the draft tokens. That is, the next token generated by the target model may be inherently or implicitly generated during the verification of draft tokens at block 330. The method 300 then continues to block 315, discussed above in more detail.

Returning to block 340, once the computing system determines that no additional tokens should be generated (e.g., at block 315 and/or block 335), the computing system outputs the generated token sequence. As discussed above, this sequence may generally include zero or more tokens generated by the target model, as well as zero or more draft tokens generated by the draft model and verified by the target model. For example, as discussed above, the computing system may output the sequence of tokens as a response to the entity that provided the prompt, or as input to a separate downstream computing system.

### Example Method for Generating Draft Tokens Using Entropy-Based Exit Criteria

FIG. 4 is a flow diagram depicting an example method 400 for generating draft tokens using entropy-based stopping criteria, according to some aspects of the present disclosure. In some aspects, the method 400 is performed by a computing system (e.g., a speculative decoding system), such as the computing system discussed above with reference to FIGS. 1-3. In some aspects, the method 400 provides additional detail for the blocks 320 and/or 325 of FIG. 3.

At block 405, the computing system generates a set of tokens (e.g., at least a portion of the draft tree 125, such as a new set of leaf tokens) using a draft generative machine learning model (e.g., the draft model 110 of FIG. 1). For example, as discussed above, the computing system may process the prompt and/or the sequence of already drafted (and/or verified) tokens as input to the draft model in order to generate a set of probabilities for a set of output logits (e.g., tokens). Collectively, this set of probabilities may form a probability distribution for the generated tokens.

At block 410, the computing system adds one or more tokens, from the set of generated tokens, to the draft tree being generated during the current drafting phase (e.g., as new leaf nodes). For example, the computing system may generate one or more new leaf tokens for each current leaf token in the draft tree (e.g., generating a set of alternative “next” tokens for each current leaf token).

Generally, the computing system may select the token(s), from the set of tokens, to be added to the tree using a variety of criteria and techniques. For example, in some aspects, the computing system may select one or more draft tokens (from the set of draft tokens for each current leaf) having the highest probability score(s) generated by the draft model (e.g., the three highest-scored tokens for each current leaf). In some aspects, other techniques which are not purely greedy may be used.

At block 415, the computing system selects one of the new leaf nodes of the draft tree (generated at block 410). Generally, the computing system may select the leaf node using a variety of techniques and criteria, including randomly or pseudo-randomly, as all of the newly generated leaf nodes will be evaluated during the method 400.

At block 420, the computing system generates a residual probability distribution of the newly generated leaf node, as discussed above. That is, as discussed above, the computing system may use Equation 1 to generate the residual probability of the selected leaf token based on the probability distribution of the leaf's parent token and/or one or more sibling token(s).

At block 425, the computing system computes an entropy for the selected leaf token based on the residual probability distribution (generated at block 420). For example, as discussed above, the computing system may compute H_{DM}(p_{x,n}) to quantify the entropy of the draft model's predictions for the selected leaf token of the current drafting phase.

At block 430, the computing system generates a drafting decision for the selected leaf token based on the computed entropy. In some aspects, as discussed above, the computing system may generate the drafting decision by determining whether one or more early-exit thresholds are satisfied. For example, as discussed above, the computing system may compute an early-exit score (e.g., score using Equation 2 above) based on the entropy for the leaf token. This score can then be compared against the early-exit threshold (e.g., λ) to determine a binary drafting decision for the selected leaf token (e.g., to continue drafting or to cease drafting).

At block 435, the computing system determines whether there is at least one additional (active) leaf node remaining in the draft tree for which a drafting decision has not yet been generated. If so, the method 400 returns to block 415. If not, the method 400 continues to block 440. Although the illustrated example depicts a sequential process (generating drafting decisions for each leaf token iteratively) for conceptual clarity, in some aspects, the computing system may generate drafting decisions for some or all of the leaf tokens entirely or partially in parallel.

At block 440, the computing system determines whether one or more stopping criteria are satisfied, such as by generating an aggregated stopping decision based on the set of drafting decisions generated at block 430. For example, as discussed above, the computing system may use a simple majority vote system, a weighted voting system, a confidence-based voting system, and the like to generate an overall decision as to whether to continue or cease drafting.

If, at block 440, the computing system determines that the stopping criteria are satisfied (e.g., if the majority of leaf tokens voted to terminate drafting), the computing system determines to terminate, exit, or otherwise end the current drafting phase, and the method 400 continues to block 445, discussed in more detail below.

Returning to block 440, if the computing system determines that the stopping criteria are not satisfied, the method 400 returns to block 405 to draft a new set of leaf tokens. Although not pictured in the illustrated example, in some aspects, the computing system may evaluate other criteria at block 440, such as whether one or more length or depth criteria are satisfied.

At block 445, the computing system returns the set of draft tokens (e.g., at least a portion of the draft tree) for verification (e.g., by the target model 115 of FIG. 1). For example, as discussed above, the target model may be used to accept or reject each token in the set of draft tokens, where accepted tokens are appended to the ongoing sequence of output tokens and rejected tokens are discarded.

### Example Method for Adaptive Exiting Criteria in Entropy-Based Speculative Decoding

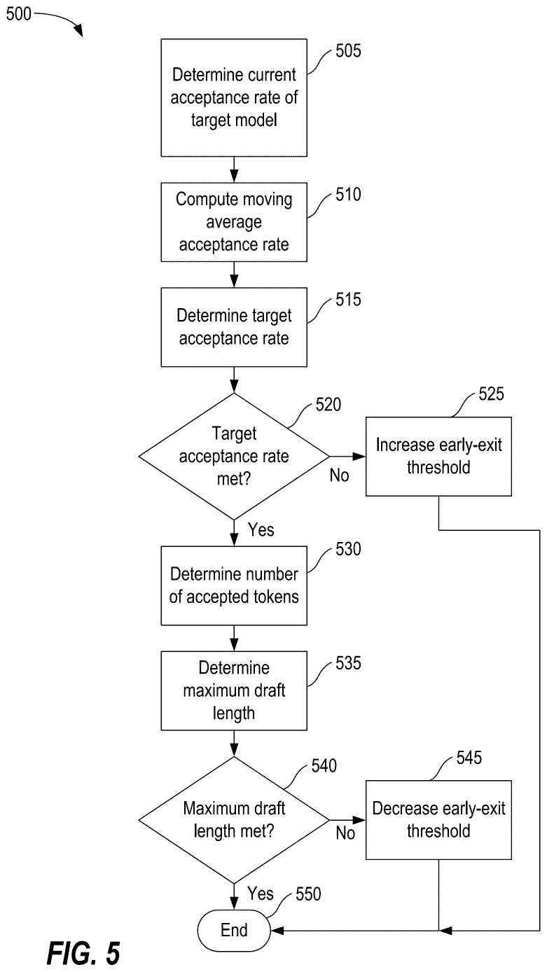

FIG. 5 is a flow diagram depicting an example method 500 for adaptive exiting criteria in entropy-based speculative decoding, according to some aspects of the present disclosure. In some aspects, the method 500 is performed by a computing system (e.g., a speculative decoding system), such as the computing system discussed above with reference to FIGS. 1-4. In some aspects, the method 500 is performed subsequent to token verification by the target model (e.g., performed at block 330 of FIG. 3).

At block 505, the computing system determines the current acceptance rate of the target model. That is, as discussed above, the computing system may determine the current percentage of draft tokens (e.g., from the draft tokens 140 of FIG. 1) that were generated by the draft model in the most recent drafting phase and were verified or accepted by the target model during the current verification phase. In some aspects, as discussed above, the current acceptance rate for the most recent drafting phase is defined as a current.

At block 510, the computing system computes an updated moving average acceptance rate of the target model based on the current acceptance rate. For example, as discussed above, the computing system may use the current acceptance rate (α_{current}) and the prior moving acceptance rate (e.g., α_{previous_ma} determined during the previous verification phase) to generate an updated moving average acceptance rate (e.g., α_{updated_ma}), such as by using Equation 3. In other aspects other measures may be used (e.g., exponential moving averages, etc.)

At block 515, the computing system determines the target or desired acceptance rate for the target model. For example, as discussed above, the target acceptance rate may be a hyperparameter of the model or generation process.

At block 520, the computing system determines whether the current moving average acceptance rate is less than the target acceptance rate. If so, the method 500 continues to block 525, where the computing system increases the early-exit threshold. That is, if the computing system determines that the target model is currently accepting fewer draft tokens than the target rate, the computing system may determine to increase the early-exit threshold (e.g., λ), thereby generating “stop drafting” drafting decisions for leaf tokens when the token's entropy is relatively lower (e.g., when the exit score, such as generated using Equation 2, is higher), as compared to the previous drafting phase. Stated differently, the computing system may determine that the computing system should end the drafting phase sooner and/or when entropy is relatively lower (thereby generating fewer tokens during each drafting phase), because the target model is accepting a lower percentage of the draft tokens than desired. For example, in some aspects, the computing system may use Equation 4 and/or Equation 6 to update the threshold. The method 500 then terminates at block 550 (e.g., to begin the next drafting phase with the updated early-exit threshold).

Returning to block 520, if the computing system determines that the current moving average acceptance rate is not less than (e.g., is greater than or equal to) the target acceptance rate, the method 500 continues to block 530. At block 530, the computing system determines the number of draft tokens, from the set of draft tokens generated during the most recent drafting phase, that were accepted by the target model.

At block 535, the computing system determines a maximum draft length for the models. That is, the computing system may determine the maximum number of draft tokens that should be generated using the draft model prior to ending the drafting phase and verifying the draft tokens using the target model.

At block 540, the computing system determines whether the maximum draft length is met by the number of accepted tokens (determined at block 530). That is, the computing system may determine whether, during the most recent drafting phase, the draft model was used to generate the maximum number of tokens that can be generated for each drafting phase (e.g., whether early exiting based on model entropy was performed), as well as whether the target model rejected any of the generated tokens. If the maximum length was achieved and verified (e.g., the computing system did not early exit the drafting based on model entropy and the target model accepted all of the draft tokens), the method 500 terminates at block 550 without modifying the early-exit threshold. That is, if the computing system determines that the target model accepted all of the generated tokens, the computing system may refrain from modifying the early-exit threshold (e.g., to allow the moving average acceptance rate to be updated to reflect the high level of acceptance).

Returning to block 540, if the computing system determines that the maximum draft length was not met (e.g., that the draft model did not generate the maximum allowable number of tokens, defined by the maximum draft length), the method 500 continues to block 545, where the computing system decreases the early-exit threshold. That is, if the computing system determines that the target model did not accept the maximum draft length (e.g., because the computing system early exited from the draft model and did not generate the maximum number of tokens), the computing system may determine to decrease the early-exit threshold (e.g., A), thereby resulting in more “continue drafting” decisions even when the entropy of the draft model is relatively higher (as compared to the previous drafting phase). Stated differently, the computing system may determine that the computing system should continue the drafting phase even when entropy is relatively higher (thereby generating more tokens with fewer resources, as compared to the target model), because the current moving average acceptance rate is sufficiently high and the draft model exited prior to reaching the maximum draft length. For example, in some aspects, the computing system may use Equation 5 and/or Equation 5 to update the threshold. The method 500 then terminates at block 550.

In some aspects, as discussed above, the computing system may update the early-exit threshold directly (e.g., by adding or subtracting a hyperparameter). In some aspects, after updating the early-exit threshold, the computing system may update the actual threshold used by computing an updated moving average of the threshold, such as discussed above with reference to Equation 6.

### Example Method for Speculative Decoding

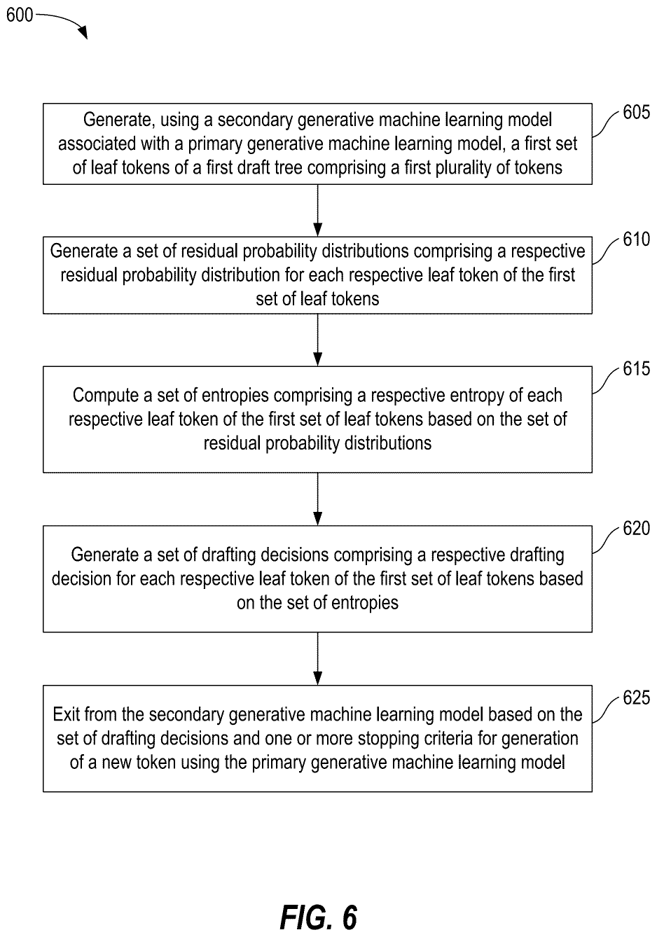

FIG. 6 is a flow diagram depicting an example method 600 for speculative decoding, according to some aspects of the present disclosure. In some aspects, the method 600 is performed by a computing system (e.g., a speculative decoding system), such as the computing system discussed above with reference to FIGS. 1-5.

At block 605, a first set of leaf tokens (e.g., the leaf tokens 220 of FIG. 2) of a first draft tree (e.g., the draft tree 125 of FIG. 1 and/or the draft tree 205 of s) comprising a first plurality of tokens is generated using a secondary generative machine learning model (e.g., the draft model 110 of FIG. 1) associated with a primary generative machine learning model (e.g., the target model 115 of FIG. 1).

At block 610, a set of residual probability distributions comprising a respective residual probability distribution for each respective leaf token of the first set of leaf tokens is generated.

At block 615, a set of entropies comprising a respective entropy of each respective leaf token of the first set of leaf tokens is computed based on the set of residual probability distributions.

At block 620, a set of drafting decisions (e.g., the drafting decisions 225 of FIG. 2) comprising a respective drafting decision for each respective leaf token of the first set of leaf tokens is generated based on the set of entropies.

At block 625, the secondary generative machine learning model is exited from based on the set of drafting decisions and one or more stopping criteria for generation of a new token using the primary generative machine learning model.

In some aspects, exiting from the secondary generative machine learning model is in response to determining, based on the set of drafting decisions, that the one or more stopping criteria are satisfied.

In some aspects, determining that the one or more stopping criteria are satisfied comprises generating an aggregated stopping decision based on the set of drafting decisions and comparing the aggregated stopping decision to the one or more stopping criteria.

In some aspects, generating the aggregated stopping decision comprises: generating a set of weights for the set of drafting decisions based on at least one of: (i) probabilities of each of the first set of leaf tokens, (ii) the set of entropies, (iii) an ordering of the first set of leaf tokens, or (iv) confidence scores of each of the first set of leaf tokens, and computing a weighted sum of the set of drafting decisions based on the set of weights.

In some aspects, the method 600 further includes submitting the first draft tree for evaluation using the primary generative machine learning model.

In some aspects, the method 600 further includes generating, using the secondary generative machine learning model, a second set of leaf tokens for a second draft tree comprising a second plurality of tokens and, in response to determining, based on entropies of the second set of leaf tokens, that the one or more stopping criteria are not satisfied, generating, using the secondary generative machine learning model, a third set of leaf tokens for the second draft tree.

In some aspects, the first set of leaf tokens is a subset of a current set of leaf tokens of the first draft tree and the first set of leaf tokens is selected, from the current set of leaf tokens, based on a respective quality score of each respective leaf token of the current set of leaf tokens.

In some aspects, generating the set of residual probability distributions comprises generating a first residual probability distribution for a first leaf token of the first set of leaf tokens according to

$${p}_{x , n} = \frac{{p}_{x} - {\sum }_{i = 1}^{n - 1} {p}_{x} ( i )}{1 - {\sum }_{i = 1}^{n - 1} {p}_{x} ( i )} ,$$

wherein: p_{x,n} is the first residual probability distribution, x is a parent token of the first leaf token, n is an index of the first leaf token, with respect to the parent token, pₓ is a probability distribution of the parent token, and pₓ(i) is a probability distribution of a leaf token at an i-th index, with respect to the parent token.

In some aspects, generating the set of drafting decisions comprises generating a first drafting decision for the first leaf token, comprising: computing an early-exit score according to 1−{square root over ((γH_{DM}(p_{x,n})))}, wherein γ is a hyperparameter and H_{DM}(p_{x,n}) is a first entropy of the first residual probability distribution for the first leaf token, and comparing the early-exit score with an early-exit threshold.

### Example Processing System for Machine Learning

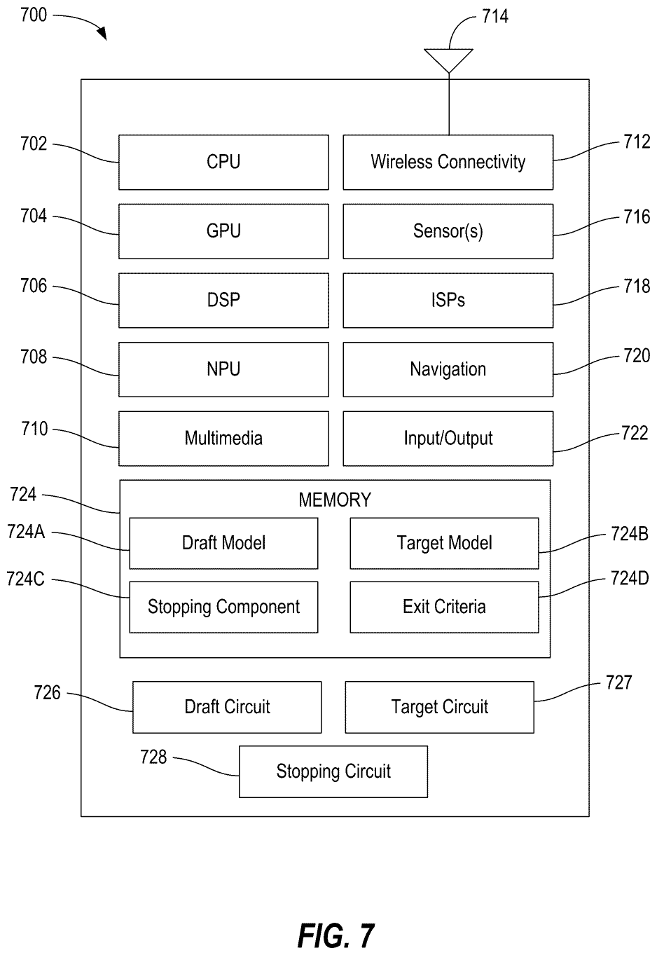

FIG. 7 depicts an example processing system 700 configured to perform various aspects of the present disclosure, including, for example, the techniques and methods described with respect to FIGS. 1-6. In some aspects, the processing system 700 may correspond to a speculative decoding system. For example, the processing system 700 may correspond to the computing systems discussed above with reference to FIGS. 1-6. Although depicted as a single system for conceptual clarity, in some aspects, as discussed above, the components described below with respect to the processing system 700 may be distributed across any number of devices or systems.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., a partition of a memory 724).

The processing system 700 also includes additional processing components tailored to specific functions, such as a graphics processing unit (GPU) 704, a digital signal processor (DSP) 706, a neural processing unit (NPU) 708, a multimedia component 710 (e.g., a multimedia processing unit), and a wireless connectivity component 712.

An NPU, such as the NPU 708, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference). In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes a memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes a draft model 724A, a target model 724B, and a stopping component 724C. Although not depicted in the illustrated example, the memory 724 may also include other components, such as a training component used to train or update machine learning model(s), and the like. Though depicted as discrete components for conceptual clarity in FIG. 7, the illustrated components (and others not depicted) may be collectively or individually implemented in various aspects.

Further, in the illustrated example, the memory 724 also includes a set of exit criteria 724D (e.g., early-exit entropy-based thresholds, which may be dynamic or adaptive or may be static, aggregation criteria defining how the individual drafting decisions should be evaluated, and the like). Although not depicted in the illustrated example, in some aspects, the memory 724 may include other data such as a training data for the machine learning model(s).

The processing system 700 further comprises a draft circuit 726, a target circuit 727, and a stopping circuit 728. The depicted circuits, and others not depicted (such as an inferencing circuit), may be configured to perform various aspects of the techniques described herein.

The draft model 724A and/or the draft circuit 726 (which may correspond to the draft model 110 of FIG. 1) may be used to generate generative machine learning model output using relatively less computational expense and/or latency, as compared to a target model, as discussed above. For example, the draft model 724A and/or the draft circuit 726 may correspond to a relatively small generative model, a subset of the components of the target model, and the like.

The target model 724B and/or the target circuit 727 (which may correspond to the target model 115 of FIG. 1) may be used to generate generative machine learning model output using relatively more computationally expensive models, as compared to the draft model, as discussed above. For example, the target model 724B and/or the target circuit 727 may correspond to a relatively large model with many parameters (e.g., an LLM or other foundation model).

The stopping component 724C and/or the stopping circuit 728 (which may correspond to the stopping component 130 of FIG. 1) may be used to determine when to early exit the drafting phase (e.g., based on entropy of the current leaf tokens in the draft tree), as discussed above. For example, the stopping component 724C and/or the stopping circuit 728 may determine whether to early exit from the draft model based on generating and evaluating drafting decisions for each leaf token.

Though depicted as separate components and circuits for clarity in FIG. 7, the draft circuit 726, the target circuit 727, and the stopping circuit 728 may collectively or individually be implemented in other processing devices of the processing system 700, such as within the CPU 702, the GPU 704, the DSP 706, the NPU 708, and the like.

Generally, the processing system 700 and/or components thereof may be configured to perform the methods described herein.

Notably, in other aspects, aspects of the processing system 700 may be omitted, such as where the processing system 700 is a server computer or the like. For example, the multimedia component 710, the wireless connectivity component 712, the sensor processing units 716, the ISPs 718, and/or the navigation processor 720 may be omitted in other aspects. Further, aspects of the processing system 700 may be distributed between multiple devices.

### Example Clauses

Implementation examples are described in the following numbered clauses:

Clause 1: A method, comprising: generating, using a secondary generative machine learning model associated with a primary generative machine learning model, a first set of leaf tokens of a first draft tree comprising a first plurality of tokens; generating a set of residual probability distributions comprising a respective residual probability distribution for each respective leaf token of the first set of leaf tokens; computing a set of entropies comprising a respective entropy of each respective leaf token of the first set of leaf tokens based on the set of residual probability distributions; generating a set of drafting decisions comprising a respective drafting decision for each respective leaf token of the first set of leaf tokens based on the set of entropies; and exiting from the secondary generative machine learning model based on the set of drafting decisions and one or more stopping criteria for generation of a new token using the primary generative machine learning model.

Clause 2: A method according to Clause 1, wherein exiting from the secondary generative machine learning model is in response to determining, based on the set of drafting decisions, that the one or more stopping criteria are satisfied.

Clause 3: A method according to Clause 2, wherein determining that the one or more stopping criteria are satisfied comprises: generating an aggregated stopping decision based on the set of drafting decisions; and comparing the aggregated stopping decision to the one or more stopping criteria.

Clause 4: A method according to Clause 3, wherein generating the aggregated stopping decision comprises: generating a set of weights for the set of drafting decisions based on at least one of: (i) probabilities of each of the first set of leaf tokens, (ii) the set of entropies, (iii) an ordering of the first set of leaf tokens, or (iv) confidence scores of each of the first set of leaf tokens; and computing a weighted sum of the set of drafting decisions based on the set of weights.

Clause 5: A method according to any of Clauses 1-4, further comprising submitting the first draft tree for evaluation using the primary generative machine learning model.

Clause 6: A method according to any of Clauses 1-5, further comprising: generating, using the secondary generative machine learning model, a second set of leaf tokens for a second draft tree comprising a second plurality of tokens; and in response to determining, based on entropies of the second set of leaf tokens, that the one or more stopping criteria are not satisfied, generating, using the secondary generative machine learning model, a third set of leaf tokens for the second draft tree.

Clause 7: A method according to any of Clauses 1-6, wherein: the first set of leaf tokens is a subset of a current set of leaf tokens of the first draft tree, and the first set of leaf tokens is selected, from the current set of leaf tokens, based on a respective quality score of each respective leaf token of the current set of leaf tokens.

Clause 8: A method according to any of Clauses 1-7, wherein generating the set of residual probability distributions comprises generating a first residual probability distribution for a first leaf token of the first set of leaf tokens according to

$${p}_{x , n} = \frac{{p}_{x} - {\sum }_{i = 1}^{n - 1} {p}_{x} ( i )}{1 - {\sum }_{i = 1}^{n - 1} {p}_{x} ( i )} ,$$

wherein: p_{x,n} is the first residual probability distribution, x is a parent token of the first leaf token, n is an index of the first leaf token, with respect to the parent token, pₓ is a probability distribution of the parent token, and pₓ(i) is a probability distribution of a leaf token at an i-th index, with respect to the parent token.

Clause 9: A method according to Clause 8, wherein generating the set of drafting decisions comprises generating a first drafting decision for the first leaf token, comprising: computing an early-exit score according to 1−{square root over ((γH_{DM}(p_{x,n})))}, wherein γ is a hyperparameter and H_{DM}(p_{x,n}) is a first entropy of the first residual probability distribution for the first leaf token; and comparing the early-exit score with an early-exit threshold.

Clause 10: A processing system comprising: a memory comprising processor-executable instructions; and one or more processors coupled to the one or more memories and configured to execute the processor-executable instructions and cause the processing system to perform a method in accordance with any of Clauses 1-9.

Clause 11: A mobile device comprising the processing system of Clause 10.

Clause 12: A processing system comprising means for performing a method in accordance with any of Clauses 1-9.

Clause 13: A non-transitory computer-readable medium comprising computer-executable instructions that, when executed by one or more processors of a processing system, cause the processing system to perform a method in accordance with any of Clauses 1-9.

Clause 14: A computer program product embodied on a computer-readable storage medium comprising code for performing a method in accordance with any of Clauses 1-9.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors coupled to the one or more memories and configured to execute the processor-executable instructions and cause the processing system to:
generate, using a secondary generative machine learning model associated with a primary generative machine learning model, a first set of leaf tokens of a first draft tree comprising a first plurality of tokens;
generate a set of residual probability distributions comprising a respective residual probability distribution for each respective leaf token of the first set of leaf tokens;
compute a set of entropies comprising a respective entropy of each respective leaf token of the first set of leaf tokens based on the set of residual probability distributions;
generate a set of drafting decisions comprising a respective drafting decision for each respective leaf token of the first set of leaf tokens based on the set of entropies; and
exit from the secondary generative machine learning model based on the set of drafting decisions and one or more stopping criteria for generation of a new token using the primary generative machine learning model.

2. The processing system of claim 1, wherein, to exit from the secondary generative machine learning model, the one or more processors are configured to execute the processor-executable instructions and cause the processing system to determine, based on the set of drafting decisions, that the one or more stopping criteria are satisfied.

3. The processing system of claim 2, wherein, to determine that the one or more stopping criteria are satisfied, the one or more processors are configured to execute the processor-executable instructions and cause the processing system to:
generate an aggregated stopping decision based on the set of drafting decisions; and
compare the aggregated stopping decision to the one or more stopping criteria.

4. The processing system of claim 3, wherein, to generate the aggregated stopping decision, the one or more processors are configured to execute the processor-executable instructions and cause the processing system to:
generate a set of weights for the set of drafting decisions based on at least one of: (i) probabilities of each of the first set of leaf tokens, (ii) the set of entropies, (iii) an ordering of the first set of leaf tokens, or (iv) confidence scores of each of the first set of leaf tokens; and
compute a weighted sum of the set of drafting decisions based on the set of weights.

5. The processing system of claim 1, wherein the one or more processors are configured to execute the processor-executable instructions and further cause the processing system to submit the first draft tree for evaluation using the primary generative machine learning model.

6. The processing system of claim 1, wherein the one or more processors are configured to execute the processor-executable instructions and further cause the processing system to:
generate, using the secondary generative machine learning model, a second set of leaf tokens for a second draft tree comprising a second plurality of tokens; and
in response to determining, based on entropies of the second set of leaf tokens, that the one or more stopping criteria are not satisfied, generate, using the secondary generative machine learning model, a third set of leaf tokens for the second draft tree.

7. The processing system of claim 1, wherein:
the first set of leaf tokens is a subset of a current set of leaf tokens of the first draft tree, and
the first set of leaf tokens is selected, from the current set of leaf tokens, based on a respective quality score of each respective leaf token of the current set of leaf tokens.

8. The processing system of claim 1, wherein, to generate the set of residual probability distributions, the one or more processors are configured to execute the processor-executable instructions and cause the processing system to generate a first residual probability distribution for a first leaf token of the first set of leaf tokens according to
$${p}_{x , n} = \frac{{p}_{x} - {\sum }_{i = 1}^{n - 1} {p}_{x} ( i )}{1 - {\sum }_{i = 1}^{n - 1} {p}_{x} ( i )} ,$$
wherein:
p_{x,n} is the first residual probability distribution,
x is a parent token of the first leaf token,
n is an index of the first leaf token, with respect to the parent token,
pₓ is a probability distribution of the parent token, and
pₓ(i) is a probability distribution of a leaf token at an i-th index, with respect to the parent token.

9. The processing system of claim 8, wherein, to generate the set of drafting decisions, the one or more processors are configured to execute the processor-executable instructions and cause the processing system to generate a first drafting decision for the first leaf token, wherein to generate the first drafting decisions, the one or more processors are configured to execute the processor-executable instructions and cause the processing system to:
compute an early-exit score according to 1−{square root over ((γH_{DM}(p_{x,n})))}, wherein γ is a hyperparameter and H_{DM}(p_{x,n}) is a first entropy of the first residual probability distribution for the first leaf token; and
compare the early-exit score with an early-exit threshold.

10. A mobile device comprising the processing system of claim 1.

11. A processor-implemented method for machine learning, comprising:
generating, using a secondary generative machine learning model associated with a primary generative machine learning model, a first set of leaf tokens of a first draft tree comprising a first plurality of tokens;
generating a set of residual probability distributions comprising a respective residual probability distribution for each respective leaf token of the first set of leaf tokens;
computing a set of entropies comprising a respective entropy of each respective leaf token of the first set of leaf tokens based on the set of residual probability distributions;
generating a set of drafting decisions comprising a respective drafting decision for each respective leaf token of the first set of leaf tokens based on the set of entropies; and
exiting from the secondary generative machine learning model based on the set of drafting decisions and one or more stopping criteria for generation of a new token using the primary generative machine learning model.

12. The processor-implemented method of claim 11, wherein exiting from the secondary generative machine learning model is in response to determining, based on the set of drafting decisions, that the one or more stopping criteria are satisfied.

13. The processor-implemented method of claim 12, wherein determining that the one or more stopping criteria are satisfied comprises:
generating an aggregated stopping decision based on the set of drafting decisions; and
comparing the aggregated stopping decision to the one or more stopping criteria.

14. The processor-implemented method of claim 13, wherein generating the aggregated stopping decision comprises:
generating a set of weights for the set of drafting decisions based on at least one of: (i) probabilities of each of the first set of leaf tokens, (ii) the set of entropies, (iii) an ordering of the first set of leaf tokens, or (iv) confidence scores of each of the first set of leaf tokens; and
computing a weighted sum of the set of drafting decisions based on the set of weights.

15. The processor-implemented method of claim 11, further comprising submitting the first draft tree for evaluation using the primary generative machine learning model.

16. The processor-implemented method of claim 11, further comprising:
generating, using the secondary generative machine learning model, a second set of leaf tokens for a second draft tree comprising a second plurality of tokens; and
in response to determining, based on entropies of the second set of leaf tokens, that the one or more stopping criteria are not satisfied, generating, using the secondary generative machine learning model, a third set of leaf tokens for the second draft tree.

17. The processor-implemented method of claim 11, wherein:
the first set of leaf tokens is a subset of a current set of leaf tokens of the first draft tree, and
the first set of leaf tokens is selected, from the current set of leaf tokens, based on a respective quality score of each respective leaf token of the current set of leaf tokens.

18. The processor-implemented method of claim 11, wherein generating the set of residual probability distributions comprises generating a first residual probability distribution for a first leaf token of the first set of leaf tokens according to
$${p}_{x , n} = \frac{{p}_{x} - {\sum }_{i = 1}^{n - 1} {p}_{x} ( i )}{1 - {\sum }_{i = 1}^{n - 1} {p}_{x} ( i )} ,$$
wherein:
p_{x,n} is the first residual probability distribution,
x is a parent token of the first leaf token,
n is an index of the first leaf token, with respect to the parent token,
pₓ is a probability distribution of the parent token, and
pₓ(i) is a probability distribution of a leaf token at an i-th index, with respect to the parent token.

19. The processor-implemented method of claim 18, wherein generating the set of drafting decisions comprises generating a first drafting decision for the first leaf token, comprising:
computing an early-exit score according to 1−{square root over ((γH_{DM}(p_{x,n})))}, wherein γ is a hyperparameter and H_{DM}(p_{x,n}) is a first entropy of the first residual probability distribution for the first leaf token; and
comparing the early-exit score with an early-exit threshold.

20. A processing system, comprising:
means for generating, using a secondary generative machine learning model associated with a primary generative machine learning model, a set of leaf tokens of a draft tree comprising a plurality of tokens;
means for generating a set of residual probability distributions comprising a respective residual probability distribution for each respective leaf token of the set of leaf tokens;
means for computing a set of entropies comprising a respective entropy of each respective leaf token of the set of leaf tokens based on the set of residual probability distributions;
means for generating a set of drafting decisions comprising a respective drafting decision for each respective leaf token of the set of leaf tokens based on the set of entropies; and
means for exiting from the secondary generative machine learning model based on the set of drafting decisions and one or more stopping criteria for generation of a new token using the primary generative machine learning model.
